(19) United States
(12) Patent Application Publication
(10) Pub. No.: US 2013/0232525 A1
(43) Pub. Date: Sep. 5, 2013

(54) METHOD AND SYSTEM FOR SPLICING ADVERTISEMENT, SPLICER, AND HEAD END DEVICE

(71) Applicant: HUAWEI TECHNOLOGIES CO., LTD., Shenzhen (CN)

(72) Inventors: Xiangsheng Xu, Nanjing (CN); Xiaojun Yan, Nanjing (CN); Jinhui Zhang, Nanjing (CN); Hui Xia, Shenzhen (CN)

(73) Assignee: Huawei Technologies Co., Ltd., Shenzhen (CN)

(21) Appl. No.: 13/866,737

(22) Filed: Apr. 19, 2013

Related U.S. Application Data
(63) Continuation of application No. PCT/CN2011/074950, filed on May 31, 2011.

(30) Foreign Application Priority Data
Oct. 21, 2010 (CN) 201010526881.2

(51) Int. Cl. H04N 21/81

(52) U.S. Cl. CPC H04N 21/812
USPC 725/36

(57) ABSTRACT

The present disclosure provides a method and system for splicing an advertisement, a splicer, and a head end device. The method includes: performing real-time transport protocol encapsulation processing on coded video data, to obtain at least one of a real-time transport protocol packet and a real-time transport protocol control protocol packet; and carrying splice information in the obtained real-time transport protocol packet or real-time transport protocol control protocol packet, and sending the real-time transport protocol packet or real-time transport protocol control protocol packet to a splicer, so that the splicer splices a received targeted advertisement into an advertisement avail of the video data according to the splice information in the received real-time transport protocol packet or real-time transport protocol control protocol packet.

### CROSS-REFERENCE TO RELATED APPLICATIONS

This application is a continuation of International Application No. PCT/CN2011/074950, filed on May 31, 2011, which claims priority to Chinese Patent Application No. 201010526881.2, filed on Oct. 21, 2010, both of which are hereby incorporated by reference in their entireties.

### FIELD

Embodiments of the present disclosure relate to the field of communication technologies, and in particular, to a method and system for splicing an advertisement, a splicer, and a head end device.

### BACKGROUND

With the development of networks, in the field of the video service providing, wired network operators implement, by using an advertisement insertion technology, region positioning advertisement insertion and precision positioning advertisement to gain economic benefits from advertisers and bring about remarkable economic profits for the advertisers. Currently, the working principles of a system for inserting an advertisement are as follows: A splicer receives video data from a head end and a targeted advertisement from an advertisement server, and inserts the targeted advertisement in an advertisement avail of program streams by using a Digital Program Insertion (DPI) technology, where the insertion is also called splicing, and forwards the spliced video data to a corresponding set-top box (STB).

In a broadcast television (BTV) scenario, the head end device of the IP television (Internet Protocol Television, abbreviated as IPTV) may send video data in MPEG2-TS over RTP over UDP mode or Codec over RTP mode. For example, in MPEG2-TS over RTP over UDP mode, Real-time Transport Protocol (RTP) encapsulation may be performed on MPEG2-TS streams, and encapsulated packets are sent to a network by using User Datagram Protocol (UDP), where each encapsulated packet has seven MPEG2-TS packets. In Codec over RTP mode, Real-time Transport Protocol encapsulation may be performed on coded video data, and encapsulated packets are sent to the network by using UDP, where the video data may be MPEG2 raw data, H264 raw data or MPEG4 raw data.

The inventor discovers that: When the head end device performs encapsulation processing on video data in RTP mode, the splicer cannot determine when to splice received targeted advertisement into the encapsulated video data, thereby failing to implement advertisement insertion services.

### SUMMARY

Embodiments of the present disclosure provide a method and system for splicing an advertisement, a splicer, and a head end device to solve the problem that when a head end device performs encapsulation processing on video data in RTP mode, the splicer cannot determine when to splice a received targeted advertisement into the encapsulated video data, thereby effectively implementing advertisement insertion services.

An embodiment of the present disclosure provides a method for splicing an advertisement. The method includes: performing real-time transport protocol encapsulation processing on coded video data, to obtain a real-time transport protocol packet and/or a real-time transport protocol control protocol packet; and carrying splice information in the obtained real-time transport protocol data packet or real-time transport protocol control protocol packet, and sending the real-time transport protocol packet or real-time transport protocol control protocol packet to a splicer, so that the splicer splices a received targeted advertisement into an advertisement avail of the video data according to the splice information in the received Real-time Transport Protocol data packet or the Real-time Transport Protocol Control Protocol packet.

An embodiment of the present disclosure also provides a method for splicing an advertisement. The method includes: receiving a real-time transport protocol data packet or real-time transport protocol control protocol packet that carries splice information; and splicing a received targeted advertisement into an advertisement avail of video data according to the splice information in the real-time transport protocol data packet or real-time transport protocol control protocol packet.

An embodiment of the present disclosure provides a head end device. The head end device includes: an encapsulation processing module, configured to perform real-time transport protocol encapsulation processing on coded video data, to obtain a real-time transport protocol packet and/or a real-time transport protocol control protocol packet; and a sending module, configured to carry splice information in the obtained real-time transport protocol packet or real-time transport protocol control protocol packet, and send the real-time transport protocol packet or real-time transport protocol control protocol packet to a splicer, so that the splicer splices a received targeted advertisement into an advertisement avail of the video data according to the splice information in the received real-time transport protocol packet or real-time transport protocol control protocol packet.

An embodiment of the present disclosure provides a splicer. The splicer includes: a first receiving module, configured to receive a real-time transport protocol data packet or real-time transport protocol control protocol packet that carries splice information; and a splicing module, configured to splice a received targeted advertisement into an advertisement avail of video data according to the splice information in the real-time transport protocol data packet or real-time transport protocol control protocol packet.

An embodiment of the present disclosure provides a system for splicing an advertisement, including a head end device and a splicer.

The head end device is configured to: perform real-time transport protocol encapsulation processing on coded video data, to obtain a real-time transport protocol packet and/or real-time transport protocol control protocol packet; carry splice information in the obtained real-time transport protocol packet or real-time transport protocol control protocol packet, and send the real-time transport protocol packet or real-time transport protocol control protocol packet to the splicer, so that the splicer splices a received targeted advertisement into an advertisement avail of the video data according to the splice information in the received real-time transport protocol packet or real-time transport protocol control protocol packet; and the splicer is configured to: receive a real-time transport protocol data packet or real-time transport protocol control protocol packet that carries splice information; and splice a received targeted advertisement into an advertisement avail of the video data according to the splice information in the real-time transport protocol packet or real-time transport protocol control protocol packet.

By using the method and system for splicing an advertisement, the splicer, and the head end device provided in embodiments of the present disclosure, RTP encapsulation processing is performed on coded video data, and an RTP packet and/or an RTCP packet is obtained; splice information is carried in the obtained RTP packet or RTCP packet, and the RTP packet or the RTCP packet is sent to a splicer, so that the splicer splices a received targeted advertisement into an advertisement avail of the video data according to the splice information in the received RTP packet or RTCP packet, which solves the problem that when a head end device performs encapsulation processing on video data in RTP mode, the splicer cannot determine when to splice a received targeted advertisement into the encapsulated video data, thereby effectively implementing advertisement insertion services.

### BRIEF DESCRIPTION OF THE DRAWINGS

To illustrate solutions in embodiments of the present disclosure more clearly, the following briefly introduces the accompanying drawings required for describing the embodiments. Apparently, the accompanying drawings in the following description show merely some embodiments of the present disclosure, and a person having ordinary skill in the art can still derive other drawings from these accompanying drawings without creative efforts.

FIG. 1 is a schematic structural diagram of a system for splicing an advertisement according to an embodiment of the present disclosure;

FIG. 2 is a flowchart of an embodiment of a method for splicing an advertisement;

FIG. 3 is a schematic diagram illustrating a format of an RTP packet carrying splice information according to an embodiment of the present disclosure;

FIG. 4 is a schematic diagram illustrating a format of an RTCP packet carrying splice information according to an embodiment of the present disclosure;

FIG. 5 is another schematic diagram illustrating a format of an RTP packet carrying splice information according to an embodiment the present disclosure;

FIG. 6 is another schematic diagram illustrating a format of an RTCP packet carrying splice information according to an embodiment of the present disclosure;

FIG. 7 is a flowchart of another embodiment of a method for splicing an advertisement;

FIG. 8 is a schematic structural diagram of an embodiment of a head end device;

FIG. 9 is a schematic structural diagram of an embodiment of a splicer; and

FIG. 10 is schematic structural diagram of an embodiment of a system for splicing an advertisement.

### DETAILED DESCRIPTION OF THE EMBODIMENTS

To make objectives, solutions, and advantages of embodiments of the present disclosure more comprehensible, the following clearly describes the solutions in the embodiments of the present disclosure with reference to the accompanying drawings in the embodiments of the present disclosure. Apparently, the described embodiments are merely a part rather than all of the embodiments of the present disclosure. All other embodiments obtained by a person having ordinary skill in the art based on the embodiments of the present disclosure without creative efforts shall fall within the protection scope of the present disclosure.

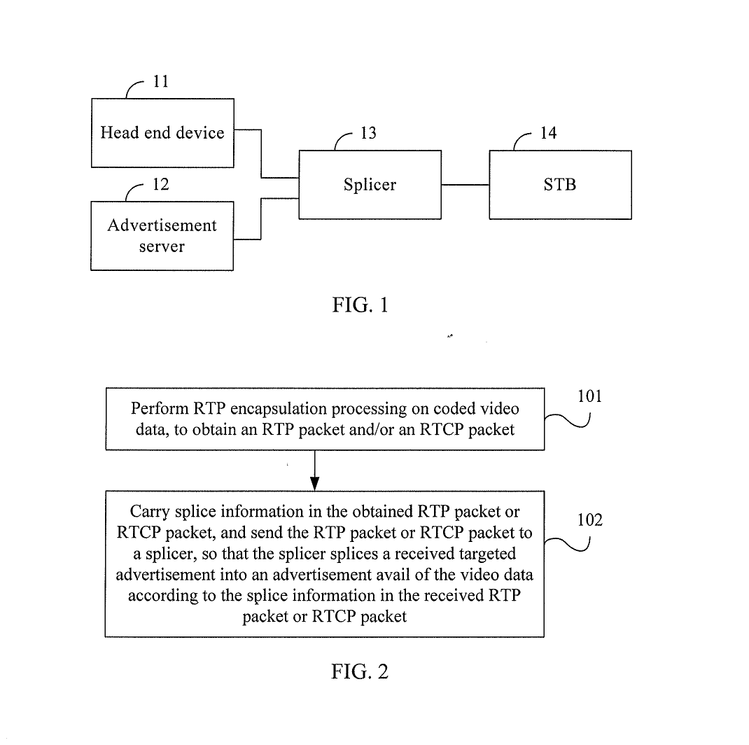

FIG. 1 is a schematic structural diagram of a system for splicing an advertisement according to an embodiment of the present disclosure. As shown in FIG. 1, the system for splicing an advertisement mainly includes a head end device (head end) 11, an advertisement server (AD server) 12, a splicer 13, and at least one STB 14. For example, the head end device 11 acts as a program source and sends video data. The video data may include an advertisement avail (AD Avail), where the AD Avail may be a fixed duration or a time point and is used to play an advertisement or a promotion. In addition, the content in the AD Avail may be changed and replaced with different advertisements of the same duration. The advertisement server 12 is a targeted advertisement provider, which may select different targeted advertisements according to the request of the splicer 13 and advertising strategies and provide the splicer 13 with the targeted advertisements. The splicer 13 receives video data and targeted advertisements, splices the targeted advertisements into the advertisement avail of the video data by using a DPI technology, and forwards the video data after the splicing to the corresponding STB 14. The STB 14 is a terminal device for receiving video data, and is capable of decoding the received video data, and playing the video data on a user display device. The display device may be a television or a liquid crystal display (LCD) or the like.

The DPI technology is a digital splicing technology used to splice a specific program into other programs. The splicing process may include splicing a single digital transport stream into a broadcast program, where the digital transport stream may be an advertisement. It should be noted that in applications of BTV, the splicer 13 may splice different advertisements for different advertising areas and different users. For example, the system includes two STBs: a first STB and a second STB, which represent users with different advertising requirements; the advertisement server 12 selects a corresponding targeted advertisement, that is, an targeted advertisement corresponding to the first STB is a first targeted advertisement, and a targeted advertisement corresponding to the second STB is a second targeted advertisement, and sends the first targeted advertisement and the second targeted advertisement to the splicer; the splicer splices each of the first targeted advertisement and the second targeted advertisement into the advertisement avail of the video data by using the DPI technology. For example, the video data spliced with the first targeted advertisement is sent to the first STB, and the video data spliced with the second targeted advertisement is sent to the second STB, so that different users can watch their interesting advertisements when watching a same program.

FIG. 2 is a flowchart of an embodiment of a method for splicing an advertisement. As shown in FIG. 2, the method in this embodiment includes:

Step 101: Perform RTP encapsulation processing on coded video data, to obtain an RTP packet and/or an RTCP packet.

In this embodiment, a head end device mainly adopts an MPEG2-TS over RTP over UDP mode or a Codec over RTP mode. For example, when the head end device adopts the Codec over RTP mode, for example, an encoder in the head end device performs RTP encapsulation on the coded video data, to obtain an RTP packet and/or an RTCP packet. The video data may include MPEG2 raw data, H264 raw data or MPEG4 raw data. A RTP is formulated by an Internet Engineering Task Force (IETF), and is a transport protocol designed for real-time transmission of multimedia data. The RTP is located above a UDP and Transmission Control Protocol (TCP), and multicasts or unicasts real-time audio and video data over UDP at a lower layer, thereby implementing multiple-point or single-point transmission of audio and video data. It should be noted that the RTP may not rely on the UDP and may be run over other transport layer protocols (for example, TCP).

The RTP may be formed by two related protocols, namely, RTP and RTCP. The RTP is used to transmit data, and RTCP is used to supervise the quality of service of the transmission and provide related session messages. An RTP packet includes a packet header and data, where the packet header includes parameters such as a sequence number (SN), a transport stream (TS), a synchronization source (SSRC)/contributing source (CSRC) list. The SN is a 16-bit numeric value and used to transport RTP data packets in sequence. The SN is plus 1 each time when the head end device sends an RTP data packet, and a splicer may, according to the SN, detect whether packet loss occurs and re-build a packet sequence. It should be noted that the RTP cannot provide a reliable mechanism for transporting data packets in sequence and nor can it provide traffic control or congestion control. Therefore, the RTP relies on the RTCP for providing services of transporting data packets in sequence and traffic control or congestion control.

Step 102: Carry splice information in the obtained RTP packet or RTCP packet, and send the RTP packet or the RTCP packet to a splicer, so that the splicer splices a received targeted advertisement into the advertisement avail of the video data according to the splice information in the received RTP packet or RTCP packet.

In this embodiment, the head end device may carry the splice information in an RTP packet, and then send the RTP packet to the splicer. After receiving the RTP packet, the splicer splices, according to the splice information carried in an RTP extension header of the RTP packet, a targeted advertisement, which is received from a targeting server, into the advertisement avail of the video data, and sends the processed video data to a set top box.

Alternatively, the head end device may carry the splice information in an RTCP packet, and then send the RTCP packet, and the RTP packet after encapsulation to the splicer. After receiving the RTCP packet and the RTP packet, the splicer splices, according to the splice information carried in the RTCP packet, a targeted advertisement, which is received from a targeting server, into the advertisement avail of the video data, and sends the processed video data to a set top box.

In this embodiment, an RTP packet and/or an RTCP packet is obtained after RTP encapsulation processing is performed on coded video data; and splice information is carried in the obtained RTP packet or RTCP packet, and the RTP packet or RTCP packet is sent to a splicer, so that the splicer splices a received targeted advertisement into the advertisement avail of the video data according to the splice information in the received RTP packet or RTCP packet, which solves a problem that when a head end device performs encapsulation processing on video data in RTP mode, the splicer cannot determine when to splice a received targeted advertisement into the encapsulated video data, thereby effectively implementing advertisement insertion services.

In another embodiment of a method for splicing an advertisement of the present disclosure, further, the splice information in step 102 may be a Society of Cable Telecommunications Engineers (SCTE) 35.

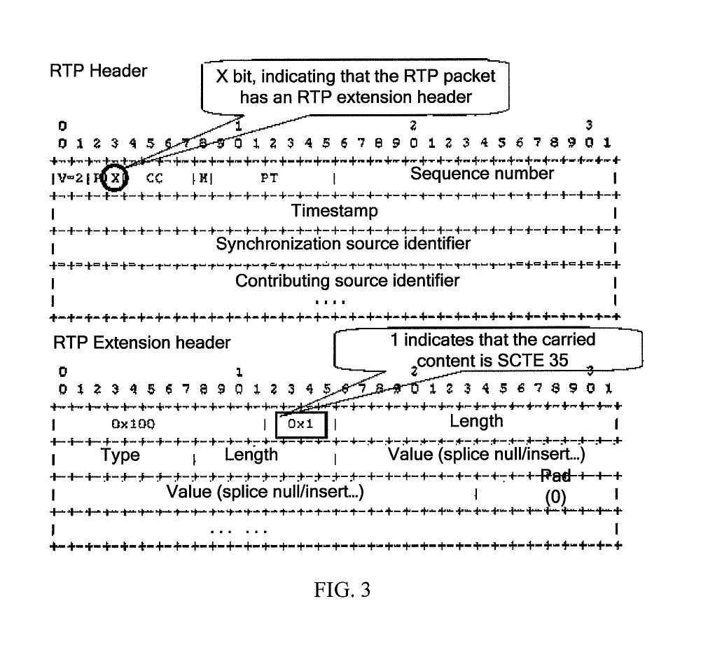

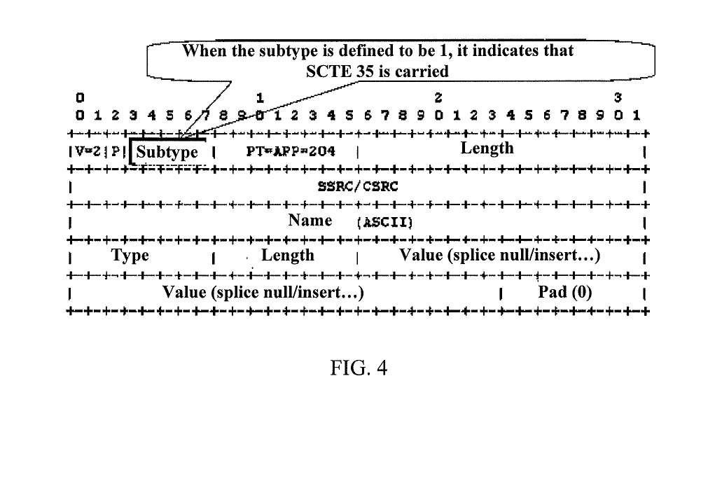

When the splice information is carried in an RTP packet, as shown in FIG. 3, FIG. 3 is a schematic diagram illustrating a format of an RTP packet carrying splice information according to the present disclosure. For example, an X bit is set in the RTP header of an RTP packet, that is, the RTP packet has an RTP extension header; and in the RTP extension header, 0x1 is used to indicate that the RTP extension header carries the SCTE 35. In addition, the RTP header includes version number (V), padding bit (P), extension bit (X), CSRC identifiers (identifiers), CSRC count (CC), mark bit (M), payload type (PT), sequence number (Sequence number), timestamp (Timestamp), and SSRC identifiers (identifiers). The RTP extension header includes length (length), type (type), value (splice null/insert . . . ) and pad (pad), and is used to indicate the content in the SCTE 35. In this embodiment, according to the specification of the Rfc5285, the bit values of the first 12 bits in the extension header of a Two-Byte Header may be 0x100, and the last four bits in the extension header may be used to specify different applications. The 16 bits are called a profile. It should be noted that the present disclosure does not limit which bit value of the last four bits in the RTP extension header indicates that the RTP extension header carries the SCTE 35. A person having ordinary skill in the art may randomly select, according to actual needs, any bit value of the last four bits in the RTP extension header to indicate that the RTP extension header carries the SCTE 35; or, when the splice information is carried in an RTCP packet, as shown in FIG. 4, FIG. 4 is a schematic diagram illustrating a format of an RTCP packet carrying splice information according to the present disclosure. For example, a subtype in an RTCP packet is set to 1 to indicate that the RTCP packet carries the SCTE 35, where the RTCP packet includes V, P, PT, application-defined RTCP packet (APP), SSRC/CSRC, name (name), type, value (splice null/insert . . . ), and pad.

In another embodiment of a method for splicing an advertisement, further, the splice information in step 102 may include a splice event information identifier, splice start time information, splice duration information and/or splice mode information. The splice event information identifier is used to identify splice event information, where the splice event information may indicate when to splice a targeted advertisement, for example, a 9 o'clock splice event information identifier is used to identify splice event information indicating that a targeted advertisement is spliced at 9 o'clock; a 10 o'clock splice event information identifier is used to identify splice event information indicating that a targeted advertisement is spliced at 10 o'clock. The splice mode information may include immediate splice mode information, timed splice mode information or canceled splice mode information. For example, the immediate splice mode information means that starting from the current time, a received targeted advertisement is immediately spliced into the AD Avail of video data. If no splice duration exists, splicing may be performed according to the duration of the advertisement; timed splice means that a splicer starts the splicing from a specified splice start time point. If no splice duration exists, the splicing is performed according to the duration of the advertisement. The canceled splice mode means that a current splice event is canceled.

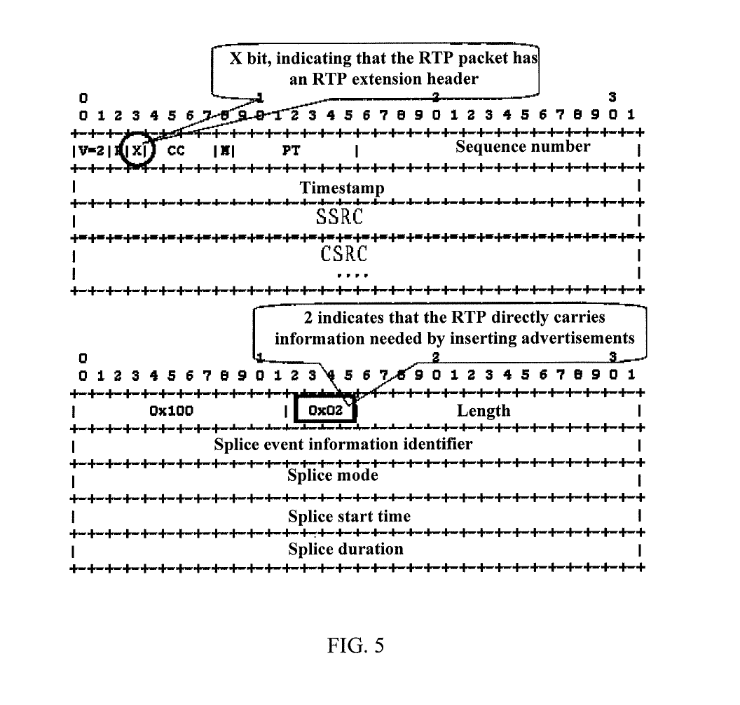

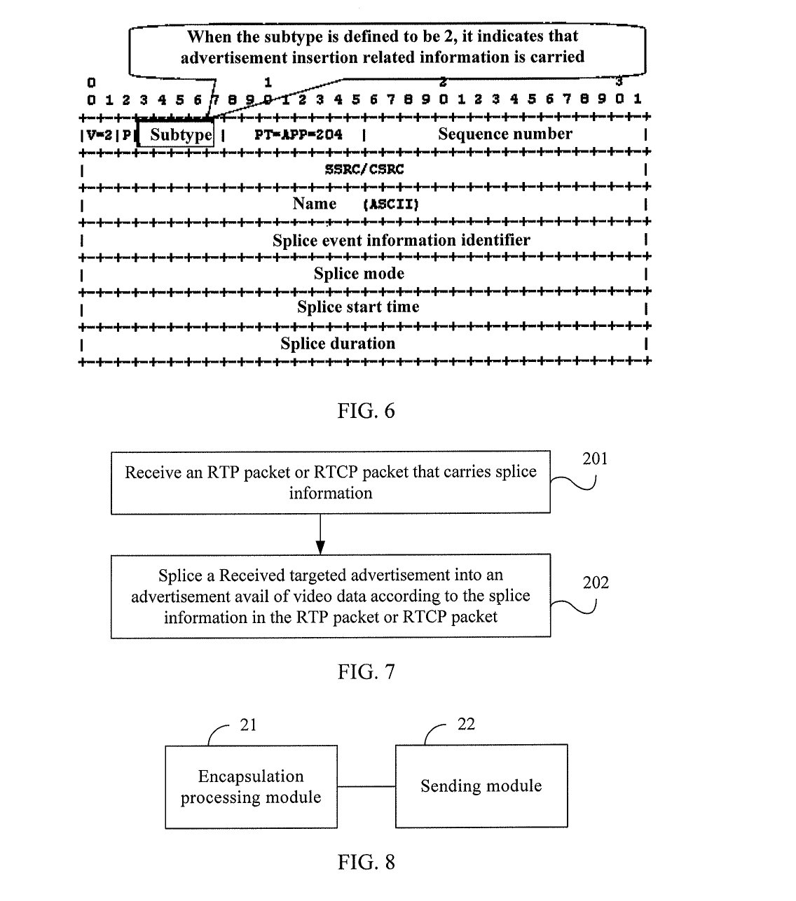

When the splice information is carried in an RTP packet, as shown in FIG. 5, FIG. 5 is another schematic diagram illustrating a format of an RTP packet carrying splice information according to the present disclosure. For example, an X bit is set in the RTP header of an RTP packet, that is, the RTP packet has an RTP extension header; and in the RTP extension header, 0x02 is used to indicate that the RTP extension header carries required splice information. The RTP header includes V, P, M, CSRC identifiers, CC, X, PT, Sequence number, Timestamp, and SSRC identifiers; the RTP extension header includes length, splice event information identifier (splice event id), splice mode (splice mode), splice start time (splice start time), and splice duration (splice duration time). It should be noted that the present disclosure does not limit which bit value of the last four bits in the RTP extension header indicates that the RTP extension header carries required splice information. A person having ordinary skill in the art may randomly select, according to actual needs, any bit value of the last four bits in the RTP extension header to indicate that the RTP extension header carries required splice information; or, when splice information is carried in an RTCP packet, as shown in FIG. 6, FIG. 6 is another schematic diagram illustrating a format of an RTCP packet carrying splice information according to the present disclosure. For example, a subtype in the RTCP packet is set to 2 to indicate that the RTCP packet carries required splice information, where the RTCP packet includes V, P, PT, APP, SSRC/CSRC, name, splice event id, splice mode, splice start time, and splice duration time. In addition, the required splice information is filled in application related data behind an RTCP APP fixed header (12 bytes).

It should be noted that the content of the splice information is not limited in the embodiment of the present disclosure and a person having ordinary skill in the art may set the content of the splice information randomly according to actual needs.

FIG. 7 is a flowchart of another embodiment of a method for splicing an advertisement. As shown in FIG. 7, the method in this embodiment includes:

Step 201: Receive an RTP packet or RTCP packet that carries splice information.

In this embodiment, for example, a head end device may perform encapsulation processing on coded video data by using RTP, carry splice information in an RTP packet, and send the RTP packet to a splicer. Alternatively, a head end device may also perform encapsulation processing on coded video data by using RTP, carry splice information in an RTCP packet, and send the RTCP packet to a splicer and meanwhile send the RTP packet after encapsulation to the splicer.

Step 202: Splice a received targeted advertisement into an advertisement avail of video data according to the splice information in the RTP packet or RTCP packet.

In this embodiment, the splice information may be SCTE 35 information; or the splice information may further include a splice event information identifier, splice start time information, splice duration information and/or splice mode information. The splice mode information may include immediate splice mode information, timed splice mode information or canceled splice mode information. For example, the immediate splice mode information means that starting from the current time, a received targeted advertisement is immediately spliced into the AD Avail of the video data. If no splice duration exists, splicing may be performed according to the duration of the advertisement; timed splice means that the splicer starts the splicing from a specified splice start time point. If no splice duration exists, the splicing is performed according to the duration of the advertisement. The canceled splice mode means that a current splice event is canceled.

It should be noted that the content of the splice information is not limited in the embodiment of the present disclosure and a person having ordinary skill in the art may set the content of the splice information randomly according to actual needs.

In addition, in this embodiment, an advertising server may select different targeted advertisements according to the request of the splicer and advertising strategies, and send the selected targeted advertisements to the splicer. The splicer determines, according to the obtained splicing information, the time when to splice the targeted advertisements, and splices the received targeted advertisements into the video data. It should also be noted that the splicer may identify different users, to splice the received different targeted advertisements according to requirements of the users, and send the video data spliced with different targeted advertisements to different users. Therefore, the method may further include:

receiving and storing a set top box identifier and a targeted advertisement identifier corresponding to the set top box identifier; and

searching for a set top box identifier corresponding to the targeted advertisement identifier of a targeted advertisement, and sending processed video data to a set top box corresponding to the set top box identifier.

The set top box identifier may be an identifier such as an IP address.

In this embodiment, an RTP packet is obtained after RTP encapsulation processing is performed on coded video data; splice information is carried in the RTP packet or an RTCP packet, and the RTP packet or the RTCP packet is sent to a splicer, so that the splicer splices a received targeted advertisement into the advertisement avail of the video data according to the splice information in the received RTP packet or RTCP packet, and sends the processed video data, which solves a problem that when encapsulation processing is performed on video data in RTP mode, the splicer cannot determine when to splice a received targeted advertisement into the encapsulated video data, thereby implementing advertisement insertion services. In particular, MPEG2-TS streams and advertisement insertion services where video data is encapsulated in Codec over RTP mode are effectively supported.

FIG. 8 is a schematic structural diagram of an embodiment of a head end device according to the present disclosure. As shown in FIG. 8, the head end device in this embodiment includes an encapsulation processing module 21 and a sending module 22. The encapsulation processing module 21 is configured to perform RTP encapsulation processing on coded video data, to obtain an RTP packet and/or an RTCP packet; the sending module 22 is configured to carry splice information in the obtained RTP packet or RTCP packet, and send the RTP packet or RTCP packet to a splicer, so that the splicer splices a received targeted advertisement into the advertisement avail of the video data according to the splice information in the received RTP packet or RTCP packet.

The head end device provided in this embodiment may be configured to execute the solution of the method embodiment shown in FIG. 2, and the principles of implementation are similar and are not further described.

In this embodiment, an RTP packet and/or an RTCP packet is obtained after RTP encapsulation processing is performed on coded video data; and splice information is carried in the obtained RTP packet or RTCP packet, and the RTP packet or the RTCP packet is sent to a splicer, so that the splicer splices a received targeted advertisement into the advertisement avail of the video data according to the splice information in the received RTP packet or RTCP packet, which solves a problem that when encapsulation processing is performed on video data in RTP mode, the splicer cannot determine when to splice a received targeted advertisement into the encapsulated video data, thereby implementing advertisement insertion services.

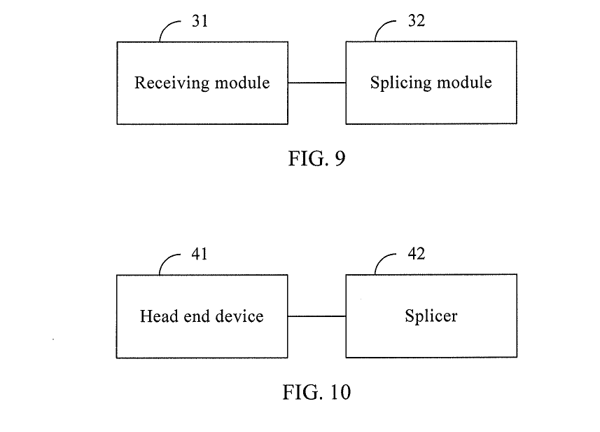

FIG. 9 is a schematic structural diagram of an embodiment of a splicer according to the present disclosure. As shown in FIG. 9, the splicer provided in this embodiment includes a receiving module 31 and a splicing module 32. The receiving module 31 is configured to receive an RTP packet or RTCP packet that carries splice information; the splicing module 32 is configured to splice a received targeted advertisement into an advertisement avail of video data according to the splice information in the RTP packet or RTCP packet.

The splicer provided in this embodiment may be configured to execute the solution of the method embodiment illustrated in FIG. 7, and the principles of implementation are similar and are not further described.

In this embodiment, an RTP packet and/or an RTCP packet is obtained after RTP encapsulation processing is performed on coded video data; and splice information is carried in the obtained RTP packet or RTCP packet, and the RTP packet or RTCP packet is sent to a splicer, so that the splicer splices a received targeted advertisement into the advertisement avail of the video data according to the splice information in the received RTP packet or RTCP packet, and sends the processed video data, which solves the problem that when encapsulation processing is performed on video data in RTP mode, the splicer cannot determine when to splice a received targeted advertisement into the encapsulated video data, thereby implementing advertisement insertion services.

In another embodiment of the present disclosure, to meet users' requirements, the splicer of the present disclosure further includes a receiving and storing module and a sending module, where the receiving and storing module is configured to receive and store a set top box identifier and a targeted advertisement identifier corresponding to the set top box identifier; and the sending module is configured to search for a set top box identifier corresponding to the targeted advertisement identifier of a targeted advertisement, and send processed video data to a set top box corresponding to the set top box identifier.

FIG. 10 is a schematic structural diagram of an embodiment of a system for splicing an advertisement according to the present disclosure. As shown in FIG. 10, the system provided in this embodiment includes a head end device 41 and a splicer 42. The head end device 41 may be configured to execute the solution of the method embodiment illustrated in FIG. 2, and the principles of implementation are similar and are not further described. The splicer 42 may be configured to execute the solution of the method embodiment illustrated in FIG. 7, and the principles of implementation are similar and are not further described.

In this embodiment, a head end device performs RTP encapsulation processing on coded video data to obtain an RTP packet and/or an RTCP packet, carries splice information in the obtained RTP packet or RTCP packet, and sends the RTP packet or the RTCP packet to a splicer, so that the splicer splices a received targeted advertisement into the advertisement avail of the video data according to the splice information in the received RTP packet or RTCP packet, and sends the processed video data, which solves the problem that when encapsulation processing is performed on video data in RTP mode, the splicer cannot determine when to splice a received targeted advertisement into the encapsulated video data, thereby implementing advertisement insertion services.

A person having ordinary skill in the art may understand that all or part of the steps of the methods in the embodiments may be implemented by a program instructing relevant hardware such as a hardware processor. The program may be stored in a computer readable storage medium accessible to the hardware processor. When the program is run, the above methods embodiments are performed. The storage medium may be any medium capable of storing program codes, such as a ROM, a RAM, a magnetic disk, or an optical disk, and the like.

Finally, it should be noted that the above embodiments of the present disclosure are merely intended for describing the solutions of the present disclosure other than limiting the present disclosure. Although the present disclosure is described in detail with reference to the foregoing embodiments, a person having ordinary skill in the art should understand that they can still make modifications to the solution described in the foregoing embodiments or make equivalent substitutions to some features thereof, without departing from the spirit and scope of the solutions of the embodiments of the present disclosure.

What is claimed is:

1. A method for splicing an advertisement, comprising:
performing real-time transport protocol encapsulation processing on coded video data, to obtain at least one of a real-time transport protocol packet and a real-time transport protocol control protocol packet; and
carrying splice information in the obtained real-time transport protocol packet or real-time transport protocol control protocol packet, and sending the real-time transport protocol packet or real-time transport protocol control protocol packet to a splicer, so that the splicer splices a received targeted advertisement into an advertisement avail of the video data according to the splice information in the received real-time transport protocol packet or real-time transport protocol control protocol packet.

2. The method according to claim 1, wherein the splice information is SCTE 35.

3. The method according to claim 1, wherein the splice information comprises at least one of a splice event information identifier, splice start time information, splice duration information and splice mode information, wherein the splice mode information comprises at least one of: immediate splice mode information, timed splice mode information; and canceled splice mode information.

4. A method for splicing an advertisement, comprising:
receiving a real-time transport protocol packet or real-time transport protocol control protocol packet that carries splice information; and
splicing a received targeted advertisement into an advertisement avail of video data according to the splice information in the real-time transport protocol packet or real-time transport protocol control protocol packet.

5. The method according to claim 4, wherein the splice information comprises SCTE 35.

6. The method according to claim 4, wherein the splice information comprises a splice event information identifier, splice start time information, splice duration information and splice mode information, wherein the splice mode information comprises immediate splice mode information, timed splice mode information or canceled splice mode information.

7. The method according to claim 5, further comprising receiving and storing a set top box identifier and a targeted advertisement identifier corresponding to the set top box identifier; and
searching for a set top box identifier corresponding to a targeted advertisement identifier of the targeted advertisement, and sending processed video data to a set top box corresponding to the set top box identifier.

8. The method according to claim 6, further comprising receiving and storing a set top box identifier and a targeted advertisement identifier corresponding to the set top box identifier; and
searching for a set top box identifier corresponding to a targeted advertisement identifier of the targeted advertisement, and sending processed video data to a set top box corresponding to the set top box identifier.

9. A system for splicing an advertisement, comprising a head end device and a splicer, wherein:
the head end device is configured to: perform real-time transport protocol encapsulation processing on coded video, to obtain at least one of a real-time transport protocol packet and a real-time transport protocol control protocol packet; and carry splice information in the obtained real-time transport protocol packet or real-time transport protocol control protocol packet, and send the real-time transport protocol packet or real-time transport protocol control protocol packet to the splicer, so that the splicer splices a received targeted advertisement into an advertisement avail of video data according to the splice information in the received real-time transport protocol packet or real-time transport protocol control protocol packet; and
the splicer is configured to: receive the real-time transport protocol packet or real-time transport protocol control protocol packet that carries the splice information; and splice the received targeted advertisement into the advertisement avail of the video data according to the splice information in the real-time transport protocol packet or real-time transport protocol control protocol packet.
